(19) United States
(12) Patent Application Publication
(10) Pub. No.: US 2025/0107962 A1
(43) Pub. Date: Apr. 3, 2025

(54) BATHTUB MASSAGE NOZZLE WITH SWITCH FUNCTION

(71) Applicant: Guangzhou Rising Dragon Recreation Industrial Co., Ltd., Guangzhou (CN)

(72) Inventors: Huaibin ZHAO, Guangzhou (CN); Xuewen LIU, Guangzhou (CN)

(73) Assignee: Guangzhou Rising Dragon Recreation Industrial Co., Ltd., Guangzhou (CN)

(21) Appl. No.: 18/679,509

(22) Filed: May 31, 2024

(30) Foreign Application Priority Data
Sep. 28, 2023 (CN) 202322650614.1

(51) Int. Cl. A61H 33/02

(52) U.S. Cl. CPC A61H 33/027; A61H 2201/0107

(57) ABSTRACT

A bathtub massage nozzle with a switch function includes a nozzle body, a nozzle core seat and a nozzle surface cover. The nozzle core seat is provided with sealing rubber rings between a core seat water inlet hole and core seat air inlet holes, and at a side away from the core seat water inlet hole. The sealing rubber rings are compressed against an inner wall surface of the nozzle body, so that both ends of the nozzle body are hermetically connected, thereby forming a sealed air cavity with a better airtightness. When air flows in from the air inlet, the air entering from the air inlet passes through the air cavity and is mixed with water through the core seat air inlet holes, so that the Venturi effect is enhanced, and the air can have a greater acceleration and pressure, thereby creating more bubbles and stronger massage effect.

### TECHNICAL FIELD

The present invention relates to the technical field of massage nozzles, in particular to a bathtub massage nozzle with a switch function.

### BACKGROUND

Bathtub massage nozzles are a common bathroom facility designed to provide a comfortable massage experience by mixing jets of water and air to generate bubbles. Traditional massage nozzle designs usually realize massage effect through the combination of nozzle body and nozzle core seat. Venturi effect is applied between nozzle body and nozzle core seat as a key mechanism to produce the bubbles. However, there are some technical limitations in the past designs, such as air leakage from the air chamber between the air inlet and the waterway due to poor airtightness of the air chamber, which may lead to unstable Venturi effect and insufficient bubble generation, thus affecting the massage effect and user experience. Therefore, in order to overcome the limitations of traditional massage nozzle designs, there is a need to provide an improved bathtub massage nozzle with a switch function to achieve better Venturi effect and air jetting effect, so that the nozzle can generate more bubbles, thus providing an improved massage effect.

### SUMMARY

The present invention is directed to provide a bathtub massage nozzle with a switch function, which solves the problems of unstable Venturi effect and insufficient bubble generation caused by the poor air tightness of the air cavity between the nozzle air inlet and the waterway of some existing massage nozzles.

A bathtub massage nozzle with a switch function is provided which includes a nozzle body, a nozzle core seat and a nozzle surface cover. The nozzle body includes a water inlet end and an opposite water spraying end, and the water inlet end is provided with a water inlet and an air inlet. The water inlet and the air inlet are staggeredly arranged relative to each other, and the air inlet is closer to the water spraying end than the water inlet. The water spraying end forms an accommodating cavity extending to the water inlet end. The nozzle core seat is arranged in the accommodating cavity, and the nozzle core seat is provided with a core seat water inlet hole and a plurality of core seat air inlet holes. The nozzle core seat is provided with sealing rubber rings between the core seat water inlet hole and the core seat air inlet holes, and at a side away from the core seat water inlet hole. The sealing rubber rings are compressed against an inner wall surface of the nozzle body. A side of the nozzle core seat away from the core seat water inlet hole is provided with the nozzle surface cover.

Preferably, the inner wall surface of the nozzle body at the spraying end is provided with an annular groove that is concave toward an outer wall surface, and an outer side of the nozzle core seat near the nozzle surface cover is provided with an annular accommodating groove, and one sealing rubber ring is received in the annular accommodating groove, which is adapted to the annular groove. A nozzle core seat is inserted through the accommodating cavity contained in a nozzle body, and then the nozzle core seat is pressed, so that one sealing rubber ring arranged on the nozzle core seat is squeezed and compressed. When the sealing rubber ring is pressed to the annular groove arranged on the nozzle body, the sealing rubber ring returns to its original shape and expands into the annular groove, so that the nozzle core seat and the nozzle body can be closely connected and the side where the annular groove is located can be sealed. The other sealing rubber ring is compressed against the inner wall surface of the nozzle body between the water inlet and the air inlet, so that the side is sealed. When the two sides are sealed, a closed air cavity is formed, which further enhances the Venturi effect.

Preferably, a middle part of the nozzle body is provided with a support plane, a protrusion is provided on the support plane, and a cam adapted to the protrusion is provided on a side of the nozzle core seat opposite to the support plane. Further, the protrusion includes a perpendicular plane perpendicular to the support plane, an arc surface connected to the perpendicular plane and parallel to the support plane, and an inclined transition surface extending from the support plane to the arc surface.

When the cam reaches the lowest end of the protrusion where the protrusion is connected with the support plane, the protrusion comes into contact with the cam. The nozzle core seat is continually rotated, and the cam gradually moves upward (that is, toward the nozzle surface cover) along the inclined transition surface of the protrusion. The annular groove on the nozzle body can be easily separated from the sealing rubber ring on the nozzle core seat due to the force provided in the direction away from the water inlet end. The nozzle core seat is continually rotated, and the nozzle core seat can be easily removed from the nozzle body. With this design, it is simple and convenient to disassemble the nozzle body and the nozzle core seat. The user only needs to rotate the nozzle core seat to make the protrusion can be engaged with the cam, providing a force sufficient to make the annular groove on the nozzle body separate from the sealing rubber ring on the nozzle core seat. In this way, the user can easily replace, clean or repair the nozzle core seat, so as to achieve a better maintenance and use experience.

Preferably, the nozzle core seat is provided with a nozzle core at one end away from the core seat water inlet hole, and the nozzle surface cover is provided with a water outlet corresponding to the nozzle core.

Preferably, the nozzle core can be one of a spherical nozzle core, a straight nozzle core, a rotary nozzle core or a multi-port nozzle core. In use, different types of nozzle core seats (that is, different nozzle cores) can be chosen according to the user own preferences and needs, such as spherical, straight, rotary or multi-port nozzle cores, so as to obtain personalized and diversified massage effects.

Preferably, the nozzle core seat is provided with a catch slot, and the side of the nozzle surface cover is provided with a catch matched with the catch slot. During installation, the connection between the nozzle surface cover and the nozzle core seat is realized by engaging the catch on the nozzle surface cover into the catch slot at the nozzle core seat, which is simple and reliable.

Preferably, the outer side of the nozzle body is provided with an external thread. The bathtub massage nozzle with a switch function also includes a fastener with an internal thread, the fastener is screwed onto the external thread of the nozzle body, and is engaged with the nozzle surface cover so as to be installed at an installation position on the bathtub.

Compared with the prior art, the present invention has the following beneficial effects: the present invention provides a bathtub massage nozzle with a switch function, which includes the nozzle body, the nozzle core seat and the nozzle surface cover, the nozzle core seat is provided with the sealing rubber rings between the core seat water inlet hole and the core seat air inlet holes, and at the side away from the core seat water inlet hole, and the sealing rubber rings are against the inner wall surface of the nozzle body, so that both ends of the nozzle body are hermetically connected to form a sealed air cavity with a better airtightness. When air flows in from the air inlet, the air from the air inlet passes through the air cavity and is mixed into the water through the core seat air inlet hole, which enhances the Venturi effect and enables the air to have a greater acceleration and pressure when flowing through the nozzle, thus creating more bubbles and a stronger massage effect. Therefore, the bathtub massage nozzle with a switch function realizes better Venturi effect and air jetting effect, provides the users with more comfortable, richer and more personalized massage experience, and improves the function and practicability of bathtub massage facilities.

### BRIEF DESCRIPTION OF DRAWINGS

FIG. 1 is a schematic structural diagram of a bathtub massage nozzle with a switch function according to one embodiment of the present invention;

FIG. 2 is a schematic cross-sectional structure diagram of the bathtub massage nozzle with a switch function according to one embodiment of the present invention;

FIG. 3 is a schematic structural diagram of the nozzle body of the bathtub massage nozzle with a switch function according to one embodiment of the present invention;

FIG. 4 is a schematic structural diagram of the nozzle core seat of the bathtub massage nozzle with a switch function according to one embodiment of the present invention;

FIG. 5 is a schematic cross-sectional view of a bathtub massage nozzle with a switch function that includes spherical nozzle core according to one embodiment of the present invention;

FIG. 6 is a schematic cross-sectional view of a bathtub massage nozzle with a switch function that includes a multi-port nozzle core according to one embodiment of the present invention;

FIG. 7 is a schematic cross-sectional view of a bathtub massage nozzle with a switch function that includes a straight nozzle core according to one embodiment of the present invention; and

FIG. 8 is a schematic cross-sectional view of a bathtub massage nozzle with a switch function that includes a rotary nozzle core according to one embodiment of the present invention.

In the Figures:
1—Nozzle body, 2—Nozzle core seat, 3—Nozzle surface cover, 4—Fastener, 11—Water inlet, 12—Air inlet, 13—Accommodating cavity, 14—Annular groove, 15—External thread, 16—Protrusion, 21—Core seat water inlet hole, 22—core seat air inlet hole, 23—Sealing rubber ring, 25—Annular accommodating groove, 27—Cam, 28—Nozzle core, 29—Catch slot, 31—Catch.

### DESCRIPTION OF EMBODIMENTS

In order to make objectives, technical solutions and advantages of the embodiments of the present invention clearer, the technical solutions of the embodiments of the present invention will be described clearly and completely below with reference to the accompanying drawings in the embodiments of the present invention.

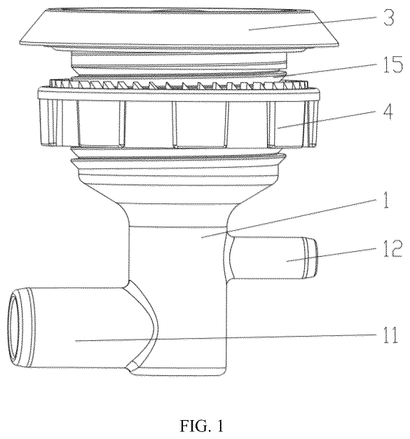

Referring to FIGS. 1-8, this embodiment provides a bathtub massage nozzle with a switch function, which includes a nozzle body 1, a nozzle core seat 2 and a nozzle surface cover 3. The nozzle body 1 includes a water inlet end and an opposite water spraying end, wherein the water inlet is provided with a water inlet 11 and an air inlet 12, which are staggeredly arranged relative to each other, and the air inlet 12 is closer to the water spraying end than the water inlet 11; and the water spraying end is formed with an accommodating cavity 13 extending to the water inlet end. The nozzle core seat 2 is arranged in the accommodating cavity 13, and includes a core seat water inlet hole 21 corresponding to the water inlet 11 and a plurality of core seat air inlet holes 22. Sealing rubber rings 23 are provided on the nozzle core seat 2 between the core seat water inlet hole 21 and the core seat air inlet holes 22, and at a side away from the core seat inlet hole 21. The sealing rubber rings 23 are compressed against an inner wall surface of the nozzle body 1. The nozzle surface cover 3 is arranged on a side of the nozzle core seat 2 away from the core seat water inlet hole 21.

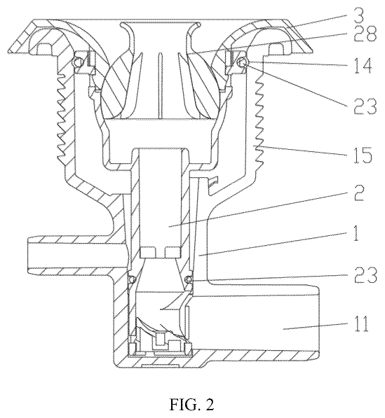

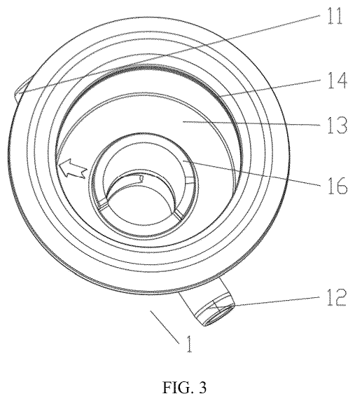

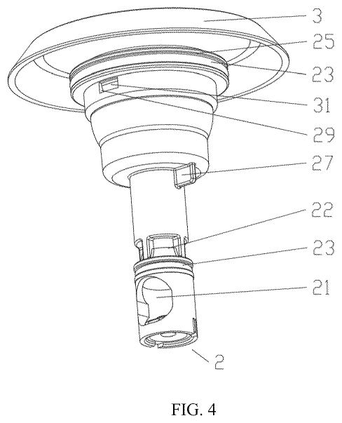

Referring to FIG. 2, FIG. 3 and FIG. 4, preferably, the inner wall surface of the nozzle body 1 at the spraying end thereof is provided with an annular groove 14 that is concave toward an outer wall surface, and an outer side of the nozzle core seat 2 near the nozzle surface cover 3 is provided with an annular accommodating groove 25, and one sealing rubber ring 23 is received in the annular accommodating groove 25, which is adapted to the annular groove 14. The nozzle core seat 2 is inserted through the accommodating cavity 13 contained in the nozzle body 1, and then the nozzle core seat 2 is pressed, so that the sealing rubber ring 23 provided on the nozzle core seat 2 is squeezed and compressed. When the sealing rubber ring 23 is pressed to the annular groove 14 provided on the nozzle body 1, the sealing rubber ring 23 returns to its original shape and expands into the annular groove 14, so that the nozzle core seat 2 and the nozzle body 1 can be closely connected and the side where the annular groove 14 is located can be sealed. The other sealing rubber ring 23 is compressed against the inner wall surface of the nozzle body 1 between the water inlet 11 and the air inlet 12, so that this side is sealed. When the two sides are sealed, a closed air cavity is formed, which enhances the Venturi effect.

Referring to FIG. 3, it is preferred that a middle part of the nozzle body 1 is provided with a support plane, a protrusion 16 is provided on the support plane, and a cam 27 adapted to the protrusion 16 is provided on a side of the nozzle core seat 2 opposite to the support plane. Further, the protrusion 16 includes a perpendicular plane perpendicular to the support plane, an arc surface connected to the perpendicular plane and parallel to the support plane, and an inclined transition surface extending from the support plane to the arc surface.

When the cam 27 reaches the lowest end of the protrusion where the protrusion 16 is connected with the support plane, the protrusion 16 comes into contact with the cam 27. The nozzle core seat 2 is continually rotated, and the cam 27 gradually moves upward (that is, toward the nozzle surface cover 3 side) along the inclined transition surface of the protrusion 16. The annular groove 14 on the nozzle body 1 can be easily separated from the sealing rubber ring on the nozzle core seat 2 due to the force provided in the direction away from the water inlet end. The nozzle core seat 2 is continually rotated, and the nozzle core seat 2 can be easily removed from the nozzle body 1. With this design, it is simple and convenient to disassemble the nozzle body 1 and the nozzle core seat 2. The user only needs to rotate the nozzle core seat 2 to make the protrusion 16 engage with the cam 27, providing a force sufficient to make the annular groove 14 on the nozzle body 1 separate from the sealing rubber ring on the nozzle core seat 2. In this way, the user can easily replace, clean or repair the nozzle core seat 2, so as to achieve a better maintenance and use experience.

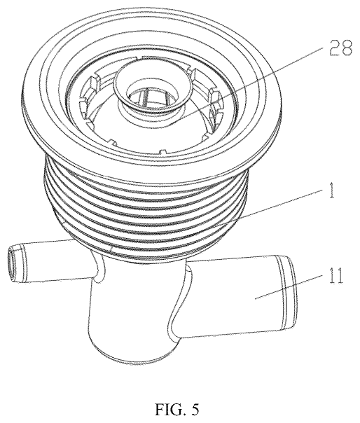

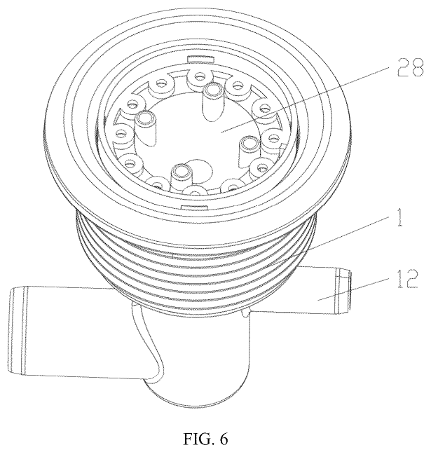

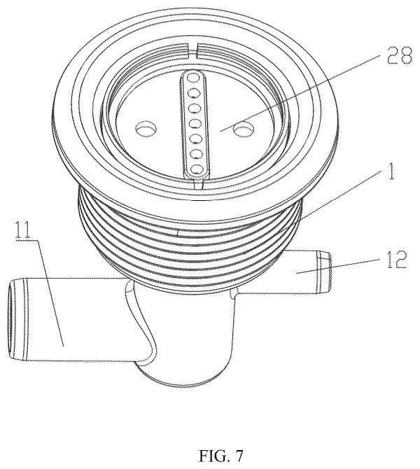

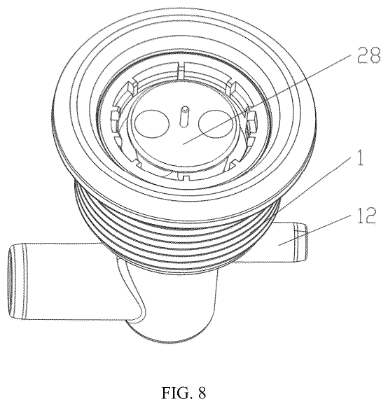

Referring to FIG. 2, FIG. 5, FIG. 6, FIG. 7 and FIG. 8, it is preferred that the nozzle core seat 2 is provided with a nozzle core 28 at one end away from the core seat water inlet hole 21, and the nozzle surface cover 3 is provided with a water outlet corresponding to the nozzle core 28. Further, the nozzle core 28 can be one of a spherical nozzle core 28, a straight nozzle core 28, a rotary nozzle core 28 or a multi-port nozzle core 28. In use, different types of nozzle core seats 2 (that is, different nozzle cores 28) can be chosen according to the user own preferences and needs, such as spherical, straight, rotary or multi-port nozzle cores 28, so as to obtain personalized and diversified massage effects.

Preferably, the nozzle core seat 2 is provided with a catch slot 29, and the side of the nozzle surface cover 3 is provided with a catch 31 engaged in the catch slot 29. During installation, the connection between the nozzle surface cover 3 and the nozzle core seat 2 is realized by engaging the catch 31 on the nozzle surface cover 3 into the catch slot 29 at the nozzle core seat 2, which is simple and reliable.

Preferably, the outer side of the nozzle body 1 is provided with an external thread 15. The bathtub massage nozzle with a switch function also includes a fastener 4 with an internal thread, the fastener 4 is screwed onto the external thread 15 of the nozzle body 1, and is engaged with the nozzle surface cover 3 so as to be installed at an installation position on the bathtub.

As described above, the present invention provides a bathtub massage nozzle with a switch function, which includes the nozzle body 1, the nozzle core seat 2 and the nozzle surface cover 3, wherein the nozzle core seat 2 is provided with the sealing rubber rings 23 between the core seat water inlet hole 21 and the core seat air inlet holes 22, and at the side away from the core seat water inlet hole 21, and the sealing rubber rings 23 are compressed against the inner wall surface of the nozzle body 1, so that both ends of the nozzle body 1 are hermetically connected to form a sealed air cavity with a better airtightness. When air flows in from the air inlet 12, the air from the air inlet 12 passes through the air cavity and is mixed into the water through the core seat air inlet hole 22, which enhances the Venturi effect and enables the air to have a greater acceleration and pressure when flowing through the nozzle, thus creating more bubbles and a stronger massage effect. Therefore, the bathtub massage nozzle with a switch function realizes better Venturi effect and air jetting effect, provides the users with more comfortable, richer and more personalized massage experience, and improves the function and practicability of bathtub massage facilities.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

What is claimed is:

1. A bathtub massage nozzle with a switch function, comprising a nozzle body, a nozzle core seat and a nozzle surface cover, wherein the nozzle body comprises a water inlet end and an opposite water spraying end, and the water inlet end is provided with a water inlet and an air inlet; the water inlet and the air inlet are staggeredly arranged relative to each other, and the air inlet is closer to the water spraying end than the water inlet; the water spraying end forms an accommodating cavity extending to the water inlet end; the nozzle core seat is arranged in the accommodating cavity, and the nozzle core seat is provided with a core seat water inlet hole and a plurality of core seat air inlet holes, and the nozzle core seat is provided with sealing rubber rings between the core seat water inlet hole and the core seat air inlet holes, and at a side away from the core seat water inlet hole; and the sealing rubber rings are tightly connected with an inner wall surface of the nozzle body; a side of the nozzle core seat away from the core seat water inlet hole is provided with the nozzle surface cover.

2. The bathtub massage nozzle with a switch function according to claim 1, wherein the inner wall surface of the nozzle body at the spraying end is provided with an annular groove which is concave toward an outer wall surface of the nozzle body, and an outer side of the nozzle core seat near the nozzle surface cover is provided with an annular accommodating groove, and the annular accommodating groove is provided with one of the sealing rubber rings that is adapted to the annular groove.

3. The bathtub massage nozzle with a switch function according to claim 1, wherein a middle part of the nozzle body is provided with a support plane, a protrusion is arranged on the support plane, and a side of the nozzle core seat opposite to the support plane is provided with a cam adapted to the protrusion.

4. The bathtub massage nozzle with a switch function according to claim 3, wherein the protrusion comprises a perpendicular plane perpendicular to the support plane, an arc surface connected with the perpendicular plane and parallel to the support plane, and an inclined transition surface extending from the support plane to the arc surface.

5. The bathtub massage nozzle with a switch function according to claim 1, wherein one end of the nozzle core seat away from the core seat water inlet hole is provided with a nozzle core, and the nozzle surface cover is provided with a water outlet corresponding to the nozzle core.

6. The bathtub massage nozzle with a switch function according to claim 5, wherein the nozzle core is one of a spherical nozzle core, a straight nozzle core, a rotary nozzle core and a multi-port nozzle core.

7. The bathtub massage nozzle with a switch function according to claim 1, wherein the nozzle core seat is provided with a catch slot, and a side of the nozzle surface cover is provided with a catch engaged in the catch slot.

8. The bathtub massage nozzle with a switch function according to claim 1, further comprising a fastener with an internal thread, and an external thread is arranged on an outside of the nozzle body, and the fastener cooperates with the nozzle surface cover to clamp the nozzle body for installation and fixation.
